(19) United States
(12) Patent Application Publication
(10) Pub. No.: US 2016/0048595 A1
(43) Pub. Date: Feb. 18, 2016

(54) Filtering Content Suggestions for Multiple Users

(71) Applicant: Lenovo (Singapore) Pte. Ltd., Singapore (SG)

(72) Inventors: Russell S. VanBlon, Raleigh, NC (US); John C. Mese, Cary, NC (US); Rod D. Waltermann, Rougemont, NC (US); Nathan J. Peterson, Durham, NC (US)

(21) Appl. No.: 14/458,207

(22) Filed: Aug. 12, 2014

(51) Int. Cl. G06F 17/30; H04L 29/06

(52) U.S. Cl. CPC G06F 17/30867; H04L 65/60

(57) ABSTRACT

An approach is provided for filtering content suggestions for a multi-user audience. In the approach, sets of preferred content types are retrieved from the various users in the multi-user content audience. A set of collective preferences is generated based on commonalities found in the sets of preferred content types pertaining to the individual users. Content metadata is then searched for the collective preferences. The result of the searching is a set of suggested content identifiers, such as movie titles, that match the collective preferences. The suggested content identifiers are then provided to the multi-user content audience.

### BACKGROUND

Selecting content to satisfy multiple people is difficult. For example, in a family with a son, mother, and a father, when choosing a streaming video to watch from an online provider, the father and son would likely choose different content than the mother and son would choose. Furthermore, a larger group of people may have to review a large amount of content before identifying content that that everyone wants to watch. Current solutions allow individual users to select and manage a single profile that identifies the user's content preferences. Content suggestions are then filtered based on the user's profile history of content choices. Such individual content suggestions are often useless when the user is part of a larger audience as other members of the audience likely will not share the same preferences and content viewing history.

### SUMMARY

An approach is provided for filtering content suggestions for a multi-user audience. In the approach, sets of preferred content types are retrieved from the various users in the multi-user content audience. A set of collective preferences is generated based on commonalities found in the sets of preferred content types pertaining to the individual users. Content metadata is then searched for the collective preferences. The result of the searching is a set of suggested content identifiers, such as movie titles, that match the collective preferences. The suggested content identifiers are then provided to the multi-user content audience.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram showing the interaction between the various components used to filter content suggestions for multiple users in one embodiment;

FIG. 4 is a flowchart showing steps taken by the user and the provider to filter content suggestions;

FIG. 5 is a flowchart showing steps taken by a process that recommends content suggestions to a multi-user audience;

FIG. 6 is a flowchart showing steps taken during the content recommendation process to combine user preferences and identify specific content to recommend to the multi-user audience; and

FIG. 7 is a flowchart showing steps taken by a process that updates multi-user profiles based content consumed by the multi-user audience.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclsoure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

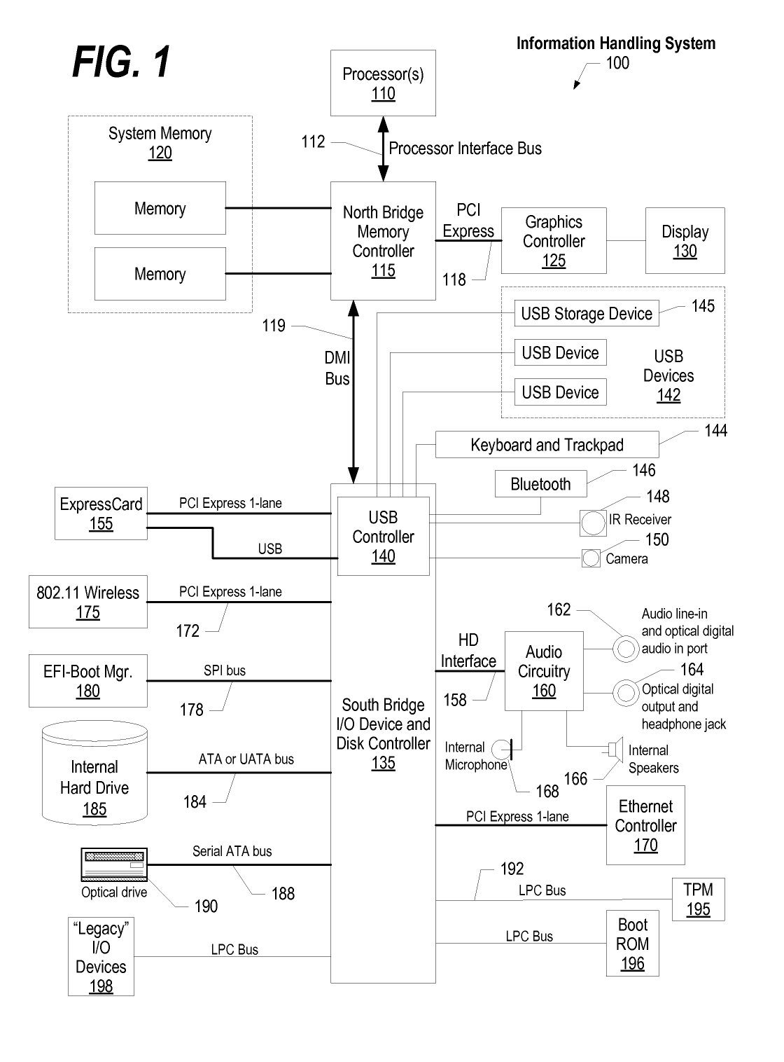

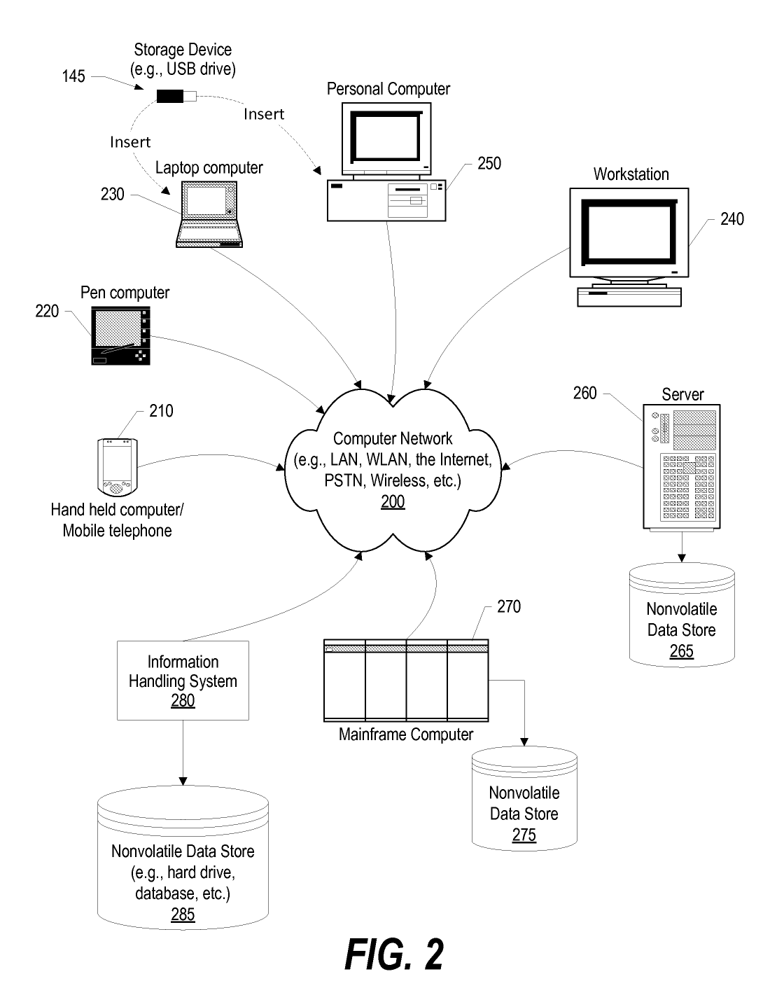

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

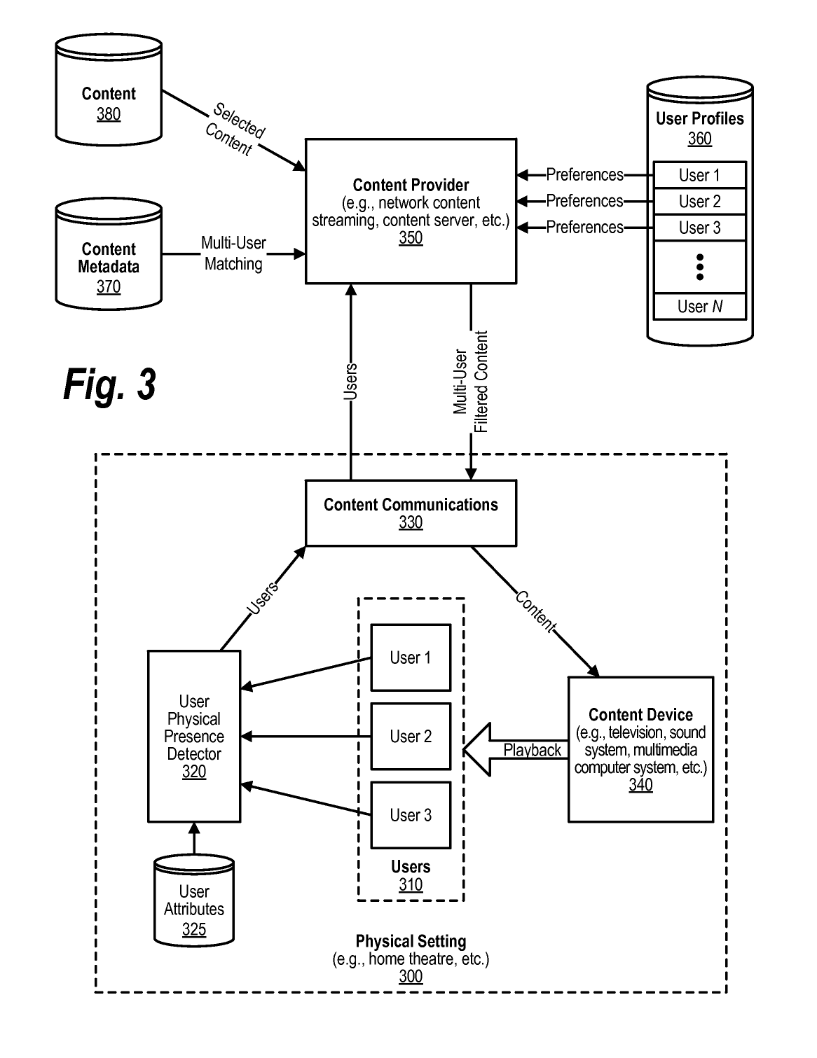

FIG. 3 is a component diagram showing the interaction between the various components used to filter content suggestions for multiple users in one embodiment. Physical setting 300 is a location, such as a home theatre room, etc. where a multi-user audience gathers to receive content, such as a movie streamed from content provider 350. The arrangement and location of the various components shown in FIG. 3 is but one embodiment. For example, content provider 350, content 380, content metadata 370, and user profiles 360 are shown being separate components from physical setting 300 with content provider connecting to the physical setting's content communications 330 via a computer network, such as the Internet. However, any one or more of these components could be included at the physical setting. For example, the content metadata and user profiles could be stored at a localized data storage device accessible from the user's content device 340 that is in physical setting 340. Likewise, with a large on-site content library, content 380 and content provider process 350 can also be located at the user's physical setting.

In the embodiment shown, physical setting 300 includes users 310 that comprise the multi-user content audience that wishes to, as a group, receive content that they can enjoy together, such as a movie. In one embodiment, user physical presence detector 320 is a device that uses biometric inputs, such as using facial recognition, to detect which individual users are in multi-user content audience 310. In such an embodiment, user attributes data store 325 is utilized by the user physical presence detector for biometric data (e.g., facial images, etc.) that are compared with the users in the multi-user content audience. If the user physical presence detector is not present or used, or if one or more of the users is not recognized by the detector, then other means, such as manual input or the like, can be used to generate the list of user identifiers that pertain to each of the users in the multi-user content audience.

Content device, such as a television, multimedia computer system, set-top television box, sound system, etc. provides playback of selected content and may also be used by the users to select the content desired for playback. Once the list of users is identified, the list of users is provided to content provider 350. The content provider may be a network-accessible content streaming provider, a content server, or the like. As previously mentioned, the content provider may be external to physical setting 300 (e.g., connected via a network connection, etc.) or may be incorporated in the physical setting, such as by including the content provider functionality in the content device.

Content provider receives a list of user identifiers of the users that are included in the multi-user content audience. User profiles 360 associated with the users in the list are retrieved to identify individual user's preferred content types. For example, one user might prefer comedies and action films, while another user might prefer dramas, documentaries, and comedies. The process generates a set of collective preferences based on commonalities found in the sets of preferred content types associated with each of the users. Content metadata 370 is searched for the collective preferences, with the searching resulting in suggested content identifiers (e.g., movie titles, etc.) that match the collective preferences. The content provider then provides the suggested content identifiers to the multi-user content audience so that they can be displayed on content device 340. The users can then select one of the suggested content identifiers for playback. The content associated with the selected content identifier is retrieved from content data store 380 and delivered to client device 340 for playback (e.g., via streaming over the Internet, etc.).

In one embodiment, the content provider identifies a disfavored content type that is disliked by at least one of the users in the multi-user content audience. This disfavored content type is not included in the collective preferences even if other users prefer such content. For example, if the profile of one user indicates that the user dislikes biographies, then biographies are not included in the collective preferences even if another of the users has a profile indicating that he or she enjoys watching biographies.

In one embodiment, the user profiles include individual preferences of the users and these individual preferences are weighed based on a strength of likeability pertaining to each of the individual preferences. For example, if a user's profile indicates that he strongly likes action movies, likes comedies, and somewhat likes dramas, then these content types would be weighed accordingly so that action movies, for this user, is given a higher weight than comedies, and comedies are given a higher weight than dramas. In a further embodiment, the weighed individual preferences of each of the users are combined, with the combining resulting in a combined weight associated with each of the content types and the search process searches the content metadata for preferred content types with higher combined weights. So, for the multi-user audience, perhaps comedies has a higher combined weight when all of the users are considered, so comedies would be preferentially searched before action movies even though one user indicated a strong liking of action movies. In yet another further embodiment, the suggested content is sorted according to the combined weight. So, using the example from above, comedies would be listed before other types of content.

As previously mentioned, in one embodiment, user physical presence detector is used to identify users in the multi-user content audience based on biometric data related to the users, such as facial images. A list of user identifiers pertaining to each of the users in the multi-user audience is generated and, during playback of the selected content, the physical presence detector tracks the presence of each of the users in the audience while the content is playing. When the detector detects an extended absence of one of the users, then the absent user is removed from the list of users in the audience. Following playback, reviews are received from users and such reviews are used in updating the user profiles associated with the list of users that are in the audience. In one embodiment, a group profile is automatically generated based on the list of user identifiers pertaining to each of the users in the multi-user audience. Reviews received from users in the audience are used to update the group profile.

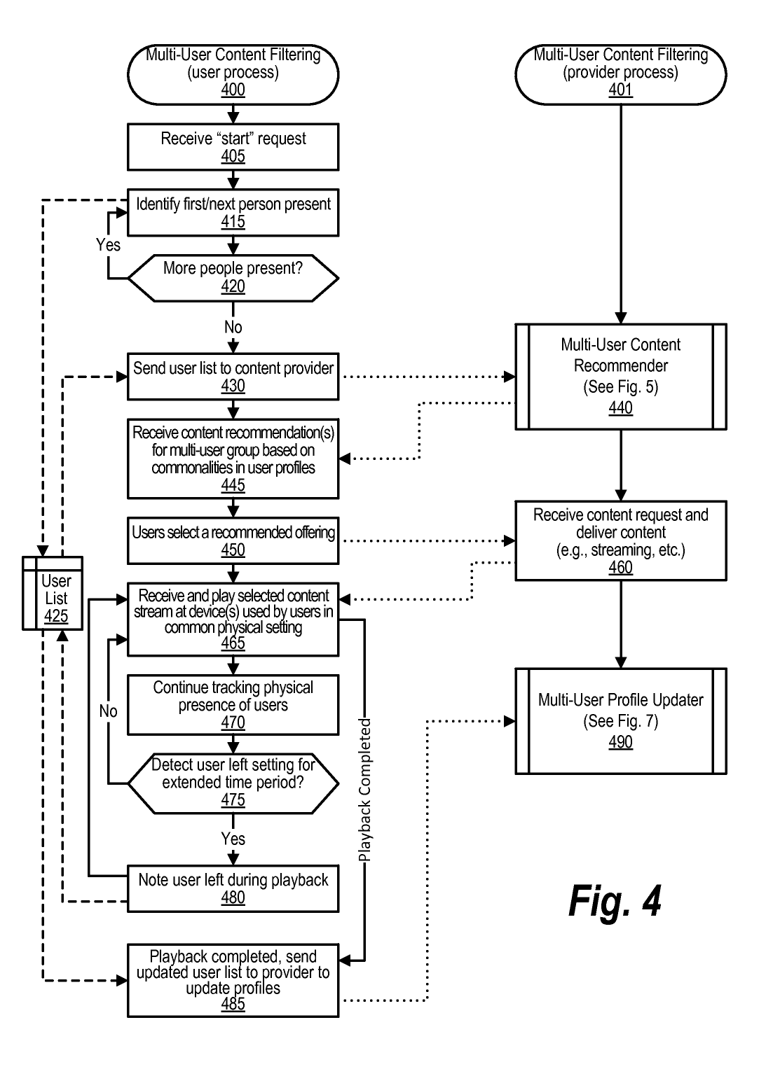

FIG. 4 is a flowchart showing steps taken by the user and the provider to filter content suggestions. User processing is shown commencing at 400 and provider processing is shown commencing at 401. As previously explained, while user and provider processing are shown separately, one or more steps in the provider processing may be performed at the user's physical setting or such steps can be performed remotely (e.g., at a network accessible location, etc.).

User processing is shown commencing at 400 whereupon, at step 405, the process receives a request to start the multi-user content filtering process. At step 415, the process, such as using a user physical presence detector, identifies the first user included in the multi-user content audience. A user identifier associated with the identified user is included in user list 425. The process determines as to whether there are more users present in the audience (decision 420). If there are more users present in the multi-user content audience, then decision 420 branches to the “yes” branch which loops back to identify the next user in the audience and store the user identifier of such user in memory area 425. This looping continues until all users in the audience have been identified and their identifiers have been stored in memory area 425, at which point decision 420 branches to the “no” branch for further processing.

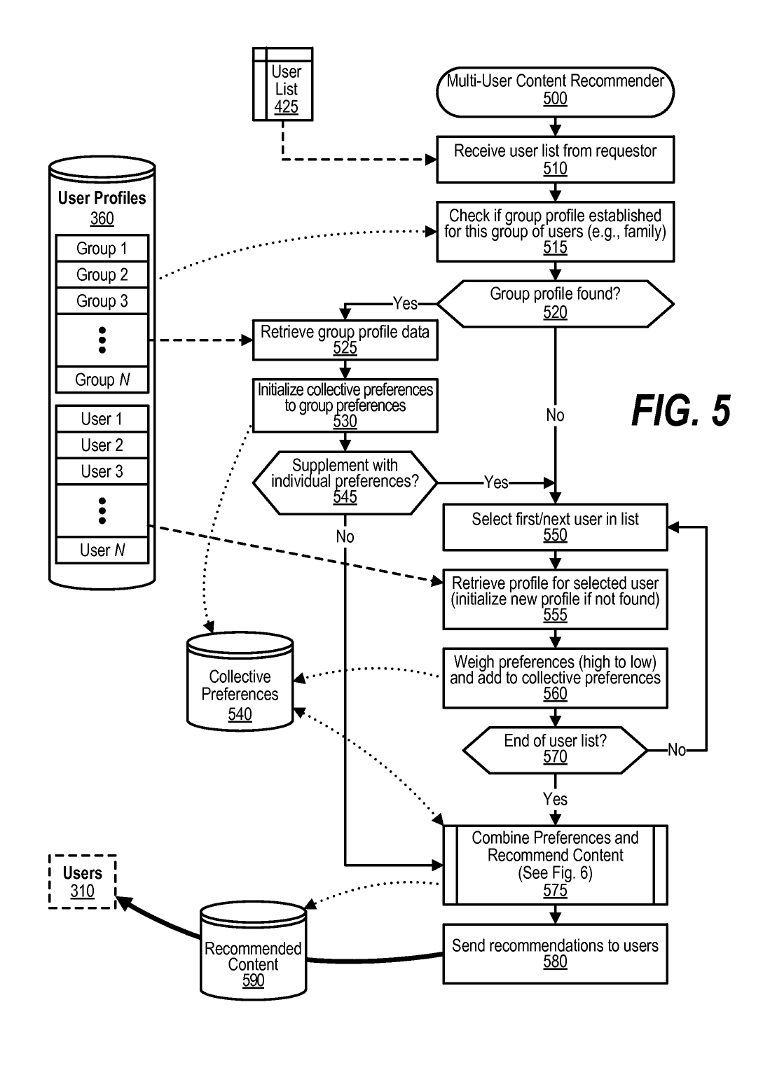

At step 430, the user list is transmitted to the content provider for processing. Provider processing commences at 401, whereupon, at predefined process 440, the provider performs a multi-user content recommender process (see FIG. 5 and corresponding text for further processing details). The result of the process is a list of suggested content identifiers (e.g., movie titles, etc.) are transmitted back to the user process.

At step 445, the user process receives the content recommendations in the form of a set of suggested content identifiers from the content provider. The suggested content identifiers are content that is recommended based on commonalities found in the individual user profiles with respect to user content type preferences. At step 450, the users select one of the suggested content identifiers to be played at the user's physical setting, such as a home theatre. The selected content identifier is transmitted to the provider process for processing. At step 460, the provider process receives the content request from the users and delivers the requested content (e.g., streaming movie, etc.).

Returning to the user process, at step 465, the user process starts receiving and playing the content delivered by the provider process where the content can be delivered to the multi-user content audience gathered in a common physical setting, such as a home theatre. At step 470, the user physical presence detector continues tracking the physical presence of each of the users in the audience. The process determines as to whether one or more of the users has been detected as having left the physical setting for an extended period of time (decision 475). For example, in a family setting, perhaps after a half hour of playback of a two hour movie, the father decides to stop watching the movie and leaves the area. If one or more users is detected as having left the physical setting for an extended period, then decision 475 branches to the “yes” branch whereupon, at step 480, the process notes the absence of such user(s) in user list 425 and loops back to step 465. On the other hand, if no users are detected as having left the physical setting for an extended time period, then decision 475 branches to the “no” branch bypassing step 480 and returning to step 465.

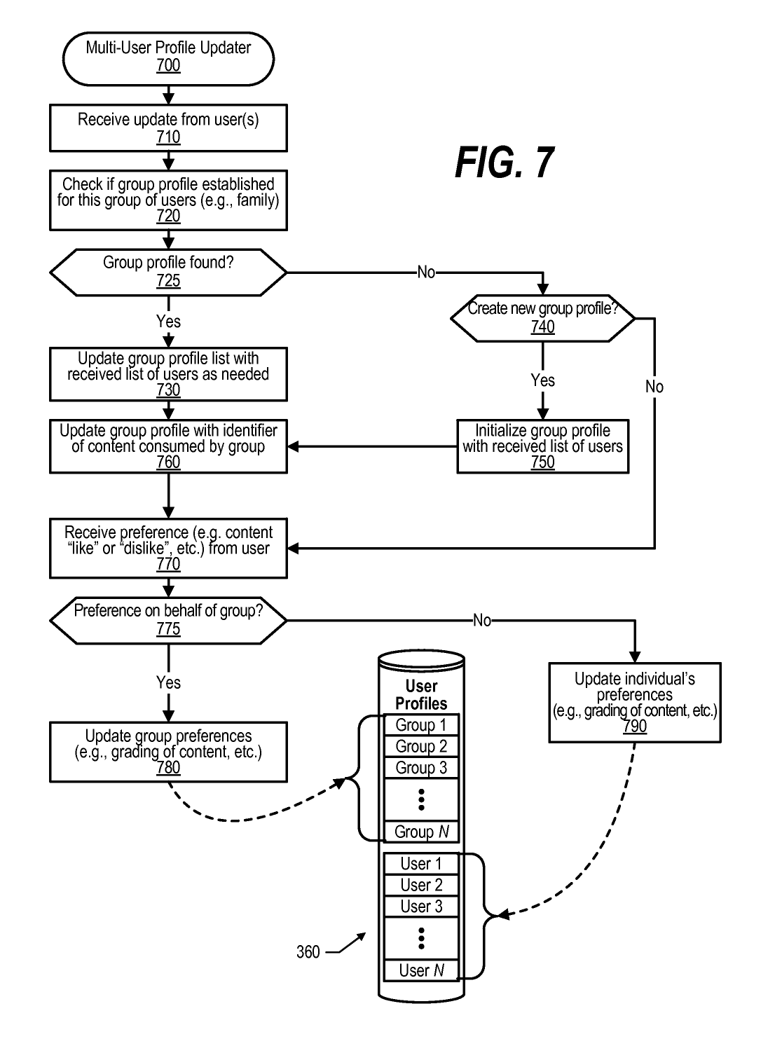

When playback of the content has completed, then the user process performs step 485 that sends the updated user list to the provider in order to update user profiles as to which users received the content along with any reviews received from such users. At predefined process 490, a multi-user profile updater is performed to update profiles associated with user list 425 (see FIG. 7 and corresponding text for further processing details).

FIG. 5 is a flowchart showing steps taken by a process that recommends content suggestions to a multi-user audience. Processing commences at 500 whereupon, at step 510, the process receives user list 425 from the requestor with user list 425 including user identifiers associated with the users in the multi-user content audience. At step 515, the process checks user profiles data store 360 for any user profiles that were previously established for this user list. For example, a family might frequently watch movies together and a group profile automatically established for the family might be used to keep track of content watched by the family as well as any reviews received from the family pertaining to such content. The process determines as to whether a group profile was found for the user list (decision 520).

If a group profile was found for the user list, then decision 520 branches to the “yes” branch whereupon, at step 525, the process retrieves the group profile data from user profile data store 360 and, at step 530, the process initializes collective preferences data store 540 to the set of group preferences. The process then determines as to whether the group preferences should be supplemented with individual preferences associated with the individuals included in the audience (decision 545). If either a group profile was not found (decision 520 branching to the “no” branch) or if the group profile is being supplemented with individual preferences (decision 545 branching to the “yes” branch), then steps 550 through 570 are performed to gather such individual preference data. On the other hand, if the group profile is not being supplemented with individual preferences, then decision 545 branches to the “no” branch bypassing steps 550 through 570.

Steps 550 through 570 are performed to gather individual preference data. At step 550, the process selects the first user from user list 425. At step 555, the process retrieves the profile of the selected user from profiles data store 360. In one embodiment, if a profile was not found for the individual, then a new profile is initialized for the user. At step 560, the user's individual preferences are weighed from high to low based upon the strength of the user's likability towards various content types. For example, if the user's profile indicates that he strongly likes action films, likes comedies, and somewhat likes dramas, then these content types are weighed accordingly (e.g., applying a weighting factor of ‘10’ for action films, an ‘8’ for comedies, and a ‘5’ for dramas, etc.). In addition, if the user indicates a strong dislike of a particular content type then this strong dislike is also weighted to indicate such dislike. For example, if this user strongly dislikes horror films, then a weighting factor of ‘0’ can be applied to horror films for this user. The weighed preferences are stored in collective preferences data store 540. The process determines as to whether all of the users from the user list have been processed (decision 570). If there are more users in the list, then decision 570 branches to the “no” branch which loops back to select and process the next user from the user list and adds such user's weighed preferences to collective preferences data store 540. This looping continues until the end of the user list has been reached, at which point decision 570 branches to the “yes” branch for further processing.

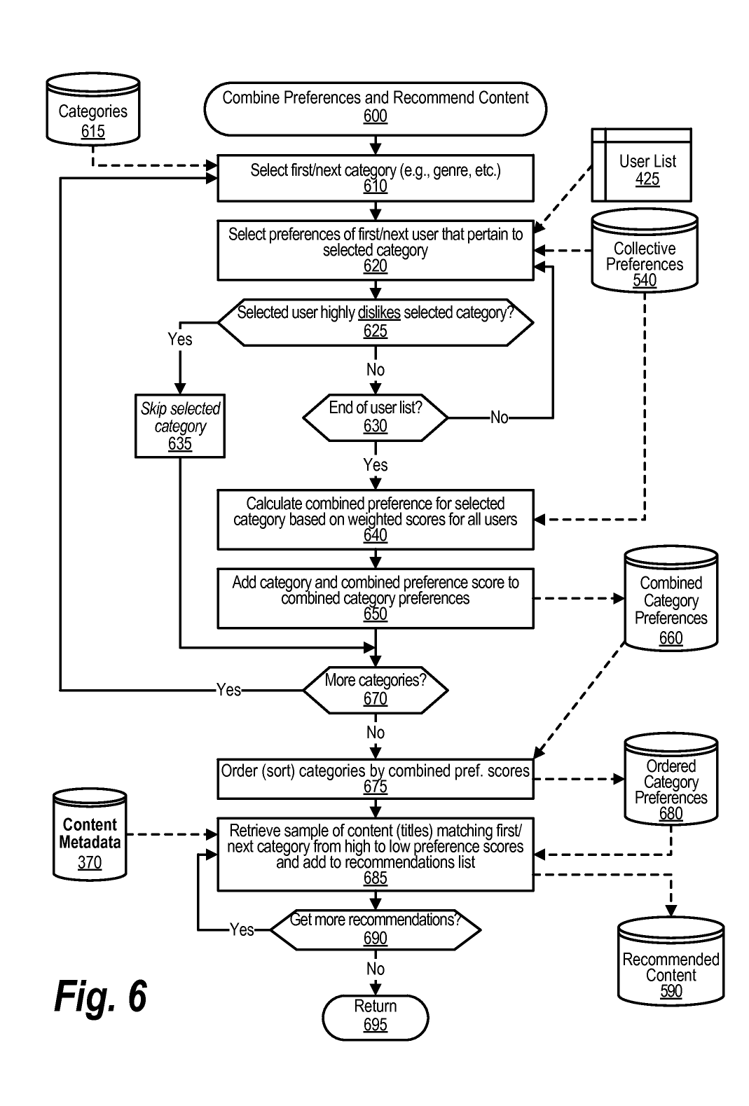

At predefined process 575, the process combines the preferences and recommends content to the multi-user content audience (see FIG. 6 and corresponding text for further processing details). The recommended content identifiers are stored in data store 590. At step 580, the process sends the recommended content identifiers to users 310 where they are displayed to the users so the users can select content that they wish to receive.

FIG. 6 is a flowchart showing steps taken during the content recommendation process to combine user preferences and identify specific content to recommend to the multi-user audience. Processing commences at 600 whereupon, at step 610, the process selects the first category, or content type, from categories data store 615. A content type might be a genre, artist, actor, etc. At step 620, the process selects the preferences associated with the first user from user list 425 with the selected preferences of the user pertaining to the selected content type. The preferences of the selected user are retrieved from collective preferences data store 540.

The process determines as to whether the selected user has noted a strong dislike of the selected content type (decision 625). For example, if the selected content type is “horror films” and the user has indicated a strong dislike of horror films, then decision 625 would branch to the “yes” branch whereupon, at step 635, this content type is skipped so that it cannot be included in combined preferences 660 with processing bypassing steps 640 and 650. On the other hand, if the user had not indicated a strong dislike of the selected content type, then decision 625 branches to the “no” branch whereupon process determines as to whether the end of the user list has been reached (decision 630). If there are still users to process to ascertain whether any of the users strongly dislike the selected content type, then decision 630 branches to the “no” branch which loops back to select the preferences associated with the next user in user list 425. This looping continues until all of the users have been processed, at which point decision 630 branches to the “yes” branch to add the content type to combined preferences data store 660. At step 640, the process calculates a combined weight for the selected content type based on the weighted preferences for all users for the selected content type. At step 650, the process adds the content type and combined weight to combined preferences data store 660.

The process determines as to whether there are more content types to process (decision 670). If there are more content types to process, then decision 670 branches to the “yes” branch which loops back to step 610 to select and process the next content type as described above. This looping continues until all of the content types have been processed, at which point decision 670 branches to the “no” branch to process the combined preferences.

At step 675, the process sorts the content types based upon their respective combined weights so that content associated with more preferred content types with higher combined weights are displayed to the users before content with lower combined weights. The sorted combined preferences are stored in data store 680. At step 685, the process retrieves a sample of content identifiers (e.g., movie titles, etc.) from content metadata 370 and the sample is added to recommendations list 590. For example, if the combined weights indicate a combined preference of comedies followed by action films and then dramas, then a sampling of comedy titles would be added to recommended content list 590 followed by a sampling of action films, and then a sampling of dramas. The sampling can take into account content previously received by users in the group so that content that is new to all users in the audience is recommended rather than recommending content already viewed by some of the users. The sampling can be based on a configuration parameter, such as based on new releases, currently popular, etc. The process determines as to whether additional recommendations should be retrieved (decision 690). If more recommendations are needed, then decision 690 branches to the “yes” branch which loops back to step 685 to receive sampling from the next content type are retrieved and added to data store 590 as described above. This looping continues until no further recommendations are needed, at which point decision 690 branches to the “no” branch and processing returns to the calling routine (see FIG. 5) at 695.

FIG. 7 is a flowchart showing steps taken by a process that updates multi-user profiles based content consumed by the multi-user audience. Processing commences at 700 whereupon, at step 710, a profile update is received from one or more users. At step 720, the process checks the profiles data store to see if a group profile has already been created for this list of users included in the audience. The process determines as to whether a group profile was found (decision 725).

If a group profile was found, then decision 725 branches to the “yes” branch whereupon, at step 730 the group profile list is updated as needed with a received list of users (e.g., adding or deleting users from the group, etc.). On the other hand, if a group profile was not found, then decision 725 branches to the “no” branch whereupon the process determines as to whether to create a new group profile for the list of users included in the audience (decision 740). If a group profile should be created, then decision 740 branches to the “yes” branch whereupon, at step 750, the group profile is initialized using the list of users in the audience. On the other hand, if a new group profile is not being created, then decision 740 branches to the “no” branch bypassing step 750.

At step 760, the group profile is updated with the content identifier of the content that was consumed by the audience. At step 770, the process receives a preference, such as a content “like” or “dislike,” from a user. The process determines as to whether the preference is being submitted on behalf of a group or on behalf of the individual user submitting the preference (decision 775). If the preference is being received on behalf of a group, then decision 775 branches to the “yes” branch whereupon, at step 780, the process updates the group preferences (e.g., grading of content, preference of one or more content types, etc.). The group profile is stored in profiles data store 360. On the other hand, if the preferences are received on behalf of the individual user, then decision 775 branches to the “no” branch whereupon, at step 790, the process updates the individual's preferences in the individual's profile. The individuals profile is also stored in profiles data store 360.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A machine-implemented method comprising:
retrieving a plurality of sets of preferred content types, wherein each of the sets corresponds to a different user of a multi-user content audience;
generating a set of collective preferences based on commonalities found in the plurality of sets of preferred content types;
searching a plurality of content metadata for the collective preferences, wherein the searching identifies a plurality of suggested content identifiers matching the collective preferences; and
providing the suggested content identifiers to the multi-user content audience.

2. The method of claim 1 further comprising:
identifying a disfavored content type, wherein the disfavored content type is disliked by at least one of the users of a multi-user content audience; and
inhibiting inclusion of the disfavored content type in the collective preferences.

3. The method of claim 1 further comprising:
retrieving a plurality of user profiles corresponding to each of the members of the multi-user content audience, wherein each of the profiles includes one or more individual preferences; and
weighing the individual preferences based on a strength of likeability pertaining to each of the individual preferences, wherein the preferred content types are ascertained from the weighed individual preferences.

4. The method of claim 3 further comprising:
combining the weighed individual preferences of each of the users included in the multi-user content audience, the combining resulting in a combined weight associated with each of the plurality of preferred content types, wherein the searching searches the plurality of content metadata for preferred content types with higher combined weights.

5. The method of claim 4 further comprising:
sorting the suggested content identifiers based on the combined weights of the preferred content types used to search the content metadata that correspond to the suggested content identifiers, wherein the suggested content identifiers are sorted before providing the suggested content identifiers to the multi-user content audience.

6. The method of claim 1 further comprising:
tracking a presence of each of the users in the multi-user audience during the playing;
detecting an extended absence of a selected one of the users of the multi-user audience; and
altering the set of collective preferences based on the extended absence.

7. The method of claim 1 further comprising:
identifying at least a selected one or more of the users in the multi-user content audience based on biometric data related to the selected one or more users;
generating a list of user identifiers pertaining to each of the users in the multi-user audience;
receiving a selection of one of the suggested content identifiers;
playing a media content corresponding to the selected suggested content identifier;
tracking a presence of each of the users in the multi-user audience during the playing;
detecting an extended absence of a selected one of the users of the multi-user audience;
removing the user identifier corresponding to the selected absent user from the list of user identifiers; and
updating one or more user profiles associated with the list of user identifiers, wherein the updating is based on one or more reviews received by the users in the multi-user audience.

8. The method of claim 1 further comprising:
generating a list of user identifiers pertaining to each of the users in the multi-user audience;
generating a group profile associated with the list of user identifiers, wherein the group profile includes the generated set of collective preferences;
receiving a selection of one of the suggested content identifiers;
playing a media content corresponding to the selected suggested content identifier;
receiving a review from one of the users in the multi-user audience; and
updating the group profile based on the received review.

9. An information handling system comprising:
one or more processors;
a memory coupled to at least one of the processors; and
a set of instructions stored in the memory and executed by at least one of the processors to:
retrieve a plurality of sets of preferred content types, wherein each of the sets corresponds to a different user of a multi-user content audience;
generate a set of collective preferences based on commonalities found in the plurality of sets of preferred content types;
search a plurality of content metadata for the collective preferences, the searching resulting in a plurality of suggested content identifiers matching the collective preferences; and
provide the suggested content identifiers to the multi-user content audience.

10. The information handling system of claim 9 wherein the set of instructions that provides the suggested content identifiers uses a content player, and wherein the set of instructions further comprises instructions to:
automatically identify one or more users in the multi-user content audience using a sensor included in the information handling system, wherein the sensor is selected from a group consisting of a camera, a Bluetooth sensor, a voice-detection sensor, and a biometric sensor.

11. The information handling system of claim 9 wherein the set of instructions further comprise instructions to:
identify a disfavored content type, wherein the disfavored content type is disliked by at least one of the users of a multi-user content audience; and
inhibit inclusion of the disfavored content type in the collective preferences.

12. The information handling system of claim 9 wherein the set of instructions further comprise instructions to:
retrieve a plurality of user profiles corresponding to each of the members of the multi-user content audience, wherein each of the profiles includes one or more individual preferences; and
weigh the individual preferences based on a strength of likeability pertaining to each of the individual preferences, wherein the preferred content types are ascertained from the weighed individual preferences.

13. The information handling system of claim 12 wherein the set of instructions further comprise instructions to:
combine the weighed individual preferences of each of the users included in the multi-user content audience, the combining resulting in a combined weight associated with each of the plurality of preferred content types, wherein the searching searches the plurality of content metadata for preferred content types with higher combined weights.

14. The information handling system of claim 9 wherein the set of instructions further comprise instructions to:
sort the suggested content identifiers based on the combined weights of the preferred content types used to search the content metadata that correspond to the suggested content identifiers, wherein the suggested content identifiers are sorted before providing the suggested content identifiers to the multi-user content audience.

15. The information handling system of claim 9 wherein the set of instructions further comprise instructions to:
track a presence of each of the users in the multi-user audience during the playing;
detect an extended absence of a selected one of the users of the multi-user audience; and
alter the set of collective preferences based on the extended absence.

16. The information handling system of claim 9 wherein the set of instructions further comprise instructions to:
identify at least a selected one or more of the users in the multi-user content audience based on biometric data related to the selected one or more users;
generate a list of user identifiers pertaining to each of the users in the multi-user audience;
receive a selection of one of the suggested content identifiers;
play a media content corresponding to the selected suggested content identifier;
track a presence of each of the users in the multi-user audience during the playing;
detect an extended absence of a selected one of the users of the multi-user audience;
remove the user identifier corresponding to the selected absent user from the list of user identifiers; and
update one or more user profiles associated with the list of user identifiers, wherein the updating is based on one or more reviews received by the users in the multi-user audience.

17. The information handling system of claim 9 wherein the set of instructions further comprise instructions to:
generating a list of user identifiers pertaining to each of the users in the multi-user audience;
generating a group profile associated with the list of user identifiers, wherein the group profile includes the generated set of collective preferences;
receiving a selection of one of the suggested content identifiers;
playing a media content corresponding to the selected suggested content identifier;
receiving a review from one of the users in the multi-user audience; and
updating the group profile based on the received review.

18. A computer program product comprising:
a computer readable storage medium comprising a set of computer instructions, the computer instructions effective to:
retrieve a plurality of sets of preferred content types, wherein each of the sets corresponds to a different user of a multi-user content audience;
generate a set of collective preferences based on commonalities found in the plurality of sets of preferred content types;
search a plurality of content metadata for the collective preferences, the searching resulting in a plurality of suggested content identifiers matching the collective preferences; and
provide the suggested content identifiers to the multi-user content audience.

19. The computer program product of claim 18 wherein the set of instructions comprise additional instructions effective to:
identify a disfavored content type, wherein the disfavored content type is disliked by at least one of the users of a multi-user content audience; and
inhibit inclusion of the disfavored content type in the collective preferences.

20. The computer program product of claim 18 wherein the set of instructions comprise additional instructions effective to:
retrieve a plurality of user profiles corresponding to each of the members of the multi-user content audience, wherein each of the profiles includes one or more individual preferences; and
weigh the individual preferences based on a strength of likeability pertaining to each of the individual preferences, wherein the preferred content types are ascertained from the weighed individual preferences.

21. The computer program product of claim 20 wherein the set of instructions comprise additional instructions effective to:
combine the weighed individual preferences of each of the users included in the multi-user content audience, the combining resulting in a combined weight associated with each of the plurality of preferred content types, wherein the searching searches the plurality of content metadata for preferred content types with higher combined weights; and
sort the suggested content identifiers based on the combined weights of the preferred content types used to search the content metadata that correspond to the suggested content identifiers, wherein the suggested content identifiers are sorted before providing the suggested content identifiers to the multi-user content audience.

22. The computer program product of claim 18 wherein the set of instructions comprise additional instructions effective to:
identify at least a selected one or more of the users in the multi-user content audience based on biometric data related to the selected one or more users;
generate a list of user identifiers pertaining to each of the users in the multi-user audience;
receive a selection of one of the suggested content identifiers;
play a media content corresponding to the selected suggested content identifier;
track a presence of each of the users in the multi-user audience during the playing;
detect an extended absence of a selected one of the users of the multi-user audience;
remove the user identifier corresponding to the selected absent user from the list of user identifiers; and
update one or more user profiles associated with the list of user identifiers, wherein the updating is based on one or more reviews received by the users in the multi-user audience.

23. The computer program product of claim 15 wherein the set of instructions comprise additional instructions effective to:
generate a list of user identifiers pertaining to each of the users in the multi-user audience;
generate a group profile associated with the list of user identifiers, wherein the group profile includes the generated set of collective preferences;
receive a selection of one of the suggested content identifiers;
play a media content corresponding to the selected suggested content identifier;
receive a review from one of the users in the multi-user audience; and
update the group profile based on the received review.
